(19) United States
(12) Patent Application Publication
(10) Pub. No.: US 2003/0136825 A1
(43) Pub. Date: Jul. 24, 2003

(54) Till tray assembly

(76) Inventor: Frederick Jay Bletzinger, Park Ridge, IL (US)

Correspondence Address: Mr. Marc D. Machtinger, Esq., Law Office of Marc D. Machtinger, Ld., suite 350, 750 W. Lake Cook Road, Buffalo Grove, IL, 60089-2073, US

(21) Appl. No.: 10/348,876

(22) Filed: Jan. 22, 2003

Related U.S. Application Data
(60) Provisional application No. 60/350,769, filed on Jan. 22, 2002.

(51) Int. Cl. G07G 1/00

(52) U.S. Cl. 235/7 R

(57) ABSTRACT

The present invention is a till tray assembly for a cash drawer having a single piece molded bill hold down bar. The seating edges of the bill hold down bar are V-shaped. The separating walls within the till tray have a cutout for receiving the bill hold-down bar which is also V-shaped. The bar is preferably sonic welded, starting from a slightly raised position, and melting or meshing into the separation wall to become fully seated. An embossment is included which extends all the way down to the bottom of the till tray to better support the hardware mounted in back of the tray. Also, an embossment in the rear of the tray aids in supporting the separating walls. The bottom surface of the tray has at least one opening, and preferably a plurality of openings so that a mold can be used to mold a lid hold down bar and tray as a single, integral piece. Extensions from the rear of the tray serve as a lid hold down bar to secure a lid to the drawer.

### TECHNICAL FIELD

The present invention relates to till tray assemblies for cash registers, and more specifically to an improved till tray assembly of the type which can be removed from a cash register and secured with a lid.

### BACKGROUND OF THE INVENTION

Various till trays for cash drawers are known and utilized for numerous purposes. A typical cash drawer has a till tray for storing paper and coin currency. The till tray is generally an open cavity with side walls, a rear wall, and separating walls spaced evenly apart from one another to form compartments to handle bills and coins of different denominations. Typical till trays have a means for placing a lid over the till tray for carrying the unit from place to place. Typical till trays also have a retaining means for holding paper bills in place so the money stays in place.

Conventional till trays have multiple piece bill hold down bar assemblies and thus are expensive to manufacture. They require an adhesive and multiple pieces to attach the bill hold down bar to separation walls in the cavity of the drawer and therefore are messy, unsteady, and complex. Additionally, they do not have adequate support for the bill hold down bar or separation walls, and require a lid hold down bar and till tray to be molded in separate pieces, yielding a high manufacturing cost.

Conventional till tray assemblies have multiple piece bill hold down bar assemblies and are thus expensive to manufacture. For example, some conventional till trays have a bill hold down bar with separate mounting portions for seating the bill hold down bar in place on a side wall or separating wall. Such till tray assemblies also have separate pieces to mount the bill retaining means in place at spaced intervals on the bill hold down bar. The result is that conventional bill hold down bar assemblies are expensive to manufacture and require much more time to assemble than would a one piece bill hold down bar assembly.

Conventional devices using adhesives to secure the bill hold down bar to the separating walls are difficult to configure such that the bill hold down bar is flush at the top with the separating walls. Such conventional assemblies require multiple pieces and adhesive to mount a bill hold down bar within a till tray.

Furthermore, conventional assemblies do not have additional support for the bill hold down bar or separation walls. The retaining means for holding bills in place within a till tray are typically connected to the rear wall of the till tray. Over time, due to repeated use, the retaining means can weaken and become difficult to use. Conventional assemblies fail to disclose additional support for the retaining means. Similarly, separation walls usually extend from the rear wall of the till tray. Conventional devices fail to address means of attempting to protect the separating walls of a till tray.

For example, U.S. Pat. No. 4,958,797 by Lyons discloses a U-shaped member used for protecting a plastic tray wall when a user breaks a wrapper of a coin roll by impacting the coin roll against a separation wall with a tray. The disclosure does not, however, disclose additional reinforcement for the separating wall.

Previous devices do not allow for single piece molding of the bottom portion, separating walls, and tabs for holding a lid. Conventional trays require that a separate flanged piece be connected to the tray in order to secure one side of a lid. Single piece molding is not possible due to the completely solid bottom of convention trays.

Other cash drawer devices are disclosed but do not disclose any means of eliminating the insufficiencies discussed above. For example, U.S. Pat. No. 5,768,965 by Gonzalez et al. discloses a cash drawer assembly having a cutter in the form of a flat plate having spaced apart top and bottom edges. The cutter is removably trapped between the till tray and the cash drawer. U.S. Pat. No. 4,412,709 by Ishii discloses a cash drawer having a compartment in the bottom of the drawer with slits for inserting checks, slips or coupons. A standard cash drawer is able to sit on top of this compartment within the drawer. U.S. Pat. No. 4,436,989 by Schuldt discloses a cash drawer having a slide-in unit and drawer tray that is able to move in and out of the slide-in unit.

It would be desirable to provide a till tray having fewer parts and greater durability.

### SUMMARY

In view of the deficiencies described above, it is an object of the present invention to provide an improved cash drawer assembly having fewer parts and greater durability.

In accordance with the above objectives, the present invention is a till tray assembly having a single piece molded bill hold down bar. The edges of the seating portion are V-shaped and may include a textured surface. The separation walls have a cutout for receiving the bill hold down bar. The cutout also preferably has a V-shaped edge, which is preferably textured. The overall shape of the cutout is preferably angled from a wide top opening to a narrower bottom opening, such as a trapezoidal shape. The bar is preferably sonic welded, starting from a slightly raised position, and “melting” or meshing the two surfaces into the separation wall to become fully seated.

An embossment is included which extends all the way down to the bottom surface of the till tray to better support the hardware mounted in the rear of the till tray. Also, an embossment for the separating walls is provided to better help support the separation walls in the rear of the till tray.

The bottom surface of the tray has at least one opening, and preferably a plurality of openings so that a mold can be used to mold a lid hold down bar as a single, integral piece with the drawer. The lid hold down bar preferably comprises extensions from the rear wall of the till tray which also serve as a lid hold down bar to secure a lid to the till tray.

A method for manufacturing the device of the present invention is additionally intended within the scope of the invention, as detailed herein.

Other features and advantages of the invention will be apparent from the following detailed description taken in conjunction with the following drawings.

### BRIEF DESCRIPTION OF THE DRAWINGS

FIG. 1 is a perspective view of a preferred embodiment of the present invention.

FIG. 2 is a sectional view of a preferred embodiment of the present invention showing a raised embossment at the rear of the till tray.

FIG. 3 is a perspective view of another embodiment of the present invention showing the shape of the bill hold down bar.

FIG. 4 is a bottom perspective view of another embodiment of the present invention showing the shape of the bottom of the bill hold down bar.

FIG. 5 is a top perspective view of another embodiment of the present invention without the bill hold down bar such that the shape of a top of the separating wall is shown.

FIG. 6 is a top perspective view of the bill hold down bar of another embodiment of the present invention showing the bill hold down bar not fully seated.

FIG. 7 is a top perspective view of a prior art till tray showing the rectangular shape of the receiving section for the bill hold down bar and the adhesive used to keep the bill hold down bar in place.

FIG. 8 is a section view of a till tray showing the shape of an embossment.

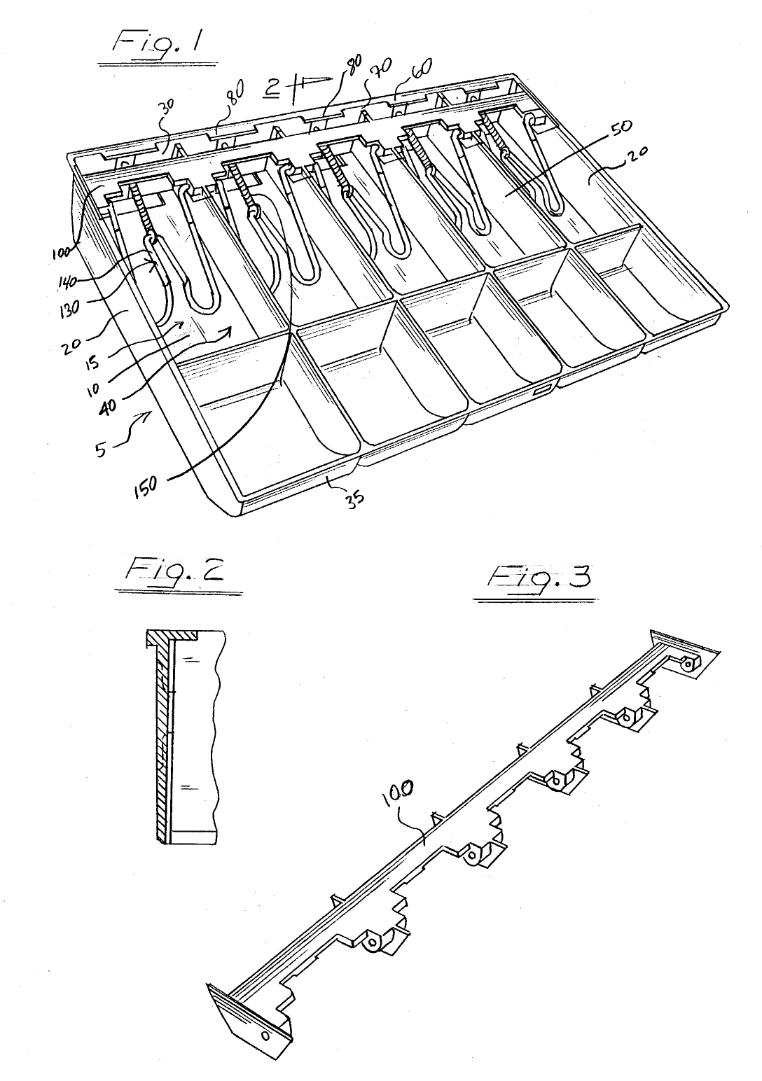

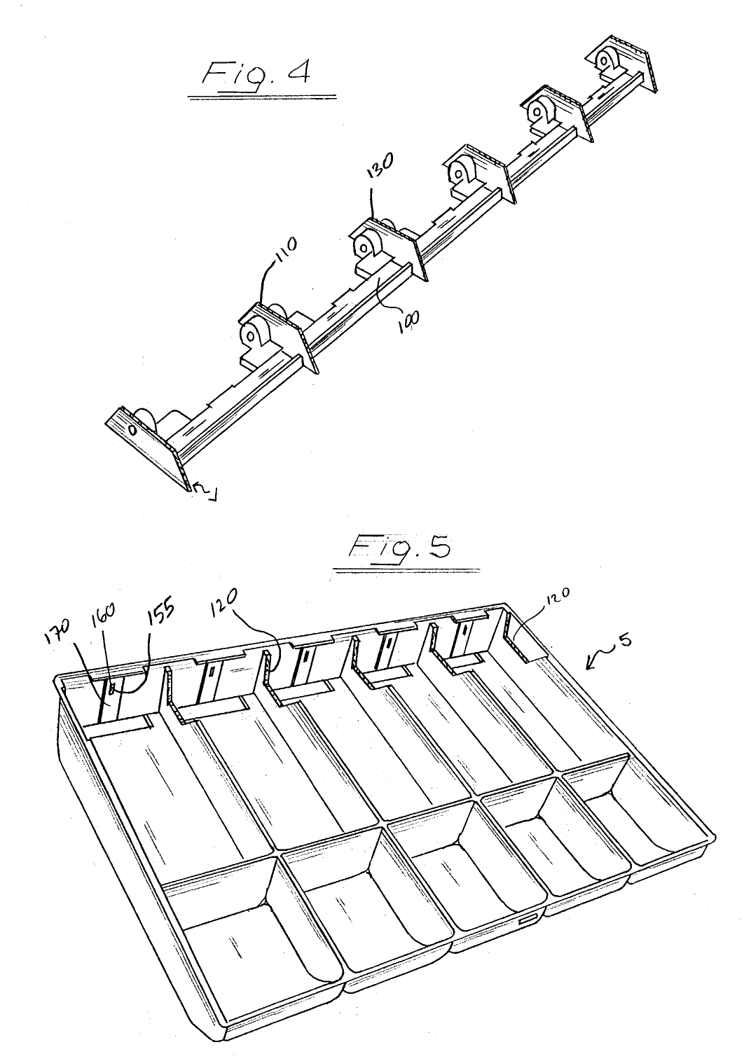

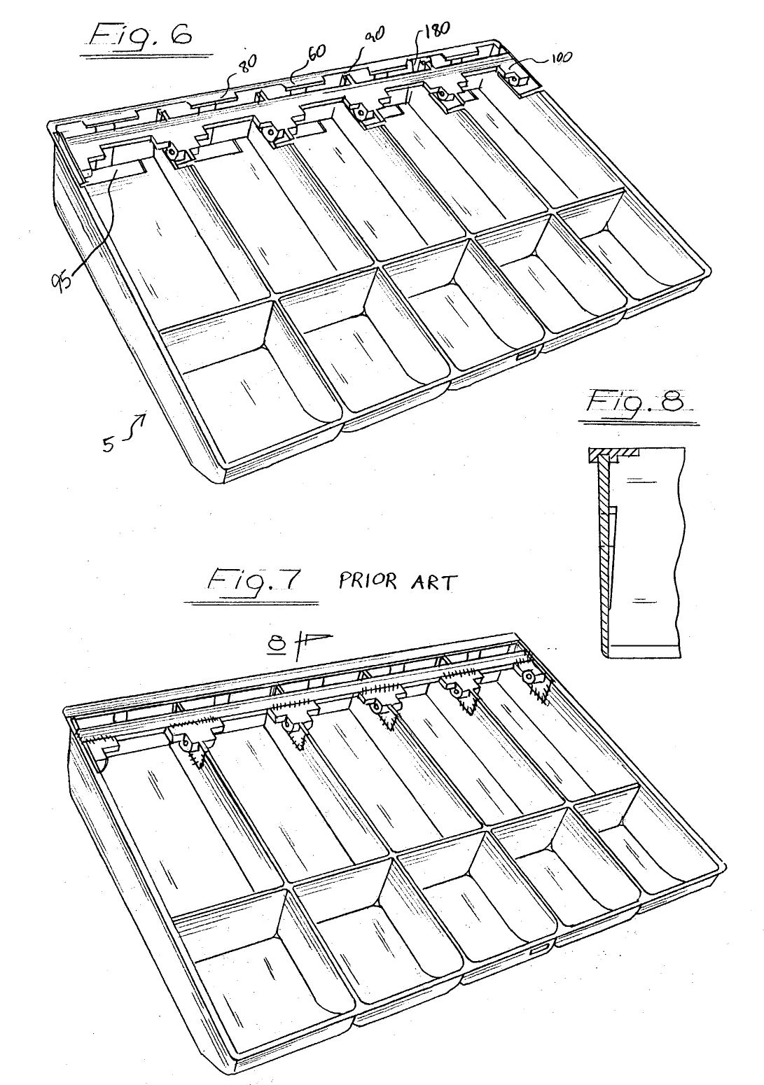

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

A till tray assembly 5 for cash registers is disclosed. The till tray 5 has a bottom portion 10 with at least two side walls 20 and a rear wall 30 that extends upwardly from the bottom portion 10. The side walls 20 and rear wall 30 form a cavity 40 open from a top side such that currency or other objects can be dropped and placed into the tray 5. The cavity 40 contains at least one dividing wall or separating wall 50 within cavity 40 which preferably extends from the bottom portion 10 or rear wall 30 to a front wall 35 of the till tray 5. The separating walls 50 form compartments 15 whereby bills or coins of different denominations are preferably stored.

There is an integrally molded lid hold down bar 60 which has a raised rear edge 70 that extends upward from the rear wall 30. This raised edge 70 is optionally integral with the rear wall 30. There is also at least one protruding tab 80 extending from the rear wall 30 with a clearance gap 90 between any protruding tab 80 and the top of any separating wall 50. The bottom portion 10 has at least one opening 95 aligned with the protruding tab 80 such that a vertical projection of the protruding tab 80 would fit entirely within opening 95. When this alignment is in place, the bottom portion 10, side walls 20, rear wall 30, separating walls 50, and the lid hold down bar 60 may be molded and formed from a single piece of plastic or other suitable material.

A bill hold down bar 100 is also formed from a single molding. The bill hold down bar 100 is disposed in spaced parallel relation to the rear wall 30 and the bill hold down bar 100 preferably extends between the side walls 20 across a top portion of the cavity 40. The bill hold down bar 100 has at least one seating portion 110 adapted to mate with a cutout 120 located at a top portion of a separating wall 50. Optionally, the seating portion 110 of the bill hold down bar 100 also mates with a cutout 120 on the top portion of side walls 20. The seating portion 110 and cutout 120 are constructed such that they will interface when the seating portion 110 of the bill hold down bar 100 is lowered into the cutout 120. In a preferred embodiment, the seating portion 110 has a V-shaped groove 130 along its bottom edge adapted to mate with a cutout 120 also having a V-shaped groove that is adapted to receive the V-shaped groove of the seating portion 110. The V-shaped groove 130 aids in keeping the bill hold down bar 100 steady. Optionally, the seating portion 110 and cutout 120 may be of any other design which securely holds the bill hold down bar 100 in place. Preferably, the cutouts 120 and seating portions 110 are formed of a trapezoidal shape. Optionally, the cutout 120 and seating portion 110 may be of any other suitable shape, and may have textured surfaces to aid in sonic welding of the parts. Preferably, a fixed interface is formed by lowering the seating portions 110 into the cutouts 120 and then sonic welding the interface. The result of sonic welding is that the top of the bill hold down bar 100 is then aligned flush with the top of any separating wall 50, and the need for adhesives is avoided.

The till tray assembly 5 contains a retaining means 130 for retaining objects, most likely dollar bills, in the compartments 15 created by separating walls 50. The retaining means 130 has a member 140 which extends from the bill hold down bar 100. Preferably, the member 140 is metal and is optionally coated with a rubberized coating. The member 140 has at least one end that is rotatably attached to the bill hold down bar 100. A tension element 150 is configured to apply a force to the member 140 to bias it toward the bottom portion 10. The tension element 150 extends between the member 140 and the rear wall 30 and is connected to the rear wall 30 by an attaching means 155. In a preferred embodiment, the attaching means 155 comprises an aperture 160 in the rear wall 30 that is large enough for an extension of the tension element 150 to fit through the aperture 160. Preferably, the extensions are bent upward or downward to hold the tension element 150 in place. The aperture 160 also has an aperture embossment or reinforcement 170 which serves to add strength and support to the retaining means 130. The aperture reinforcement 170 is preferably a thickened portion of the rear wall 30 around the aperture 160. Preferably, the aperture reinforcement 170 extends downward to the bottom portion 10. In another embodiment, there is a separating wall embossment or reinforcement 180 that is located at an intersection between a separating wall 50 and the rear wall 30 to add strength and support to the separating wall 50. The separating wall reinforcement 180 has a thickened portion along either side of the intersection.

There is also disclosed a method of manufacturing which includes the steps of providing each of the additional features and components as described above.

While the specific embodiments have been illustrated and described, numerous modifications come to mind without significantly departing from the spirit of the invention, and the scope of protection is only limited by the scope of the accompanying claims.

What is claimed is:

1. A till tray assembly for cash registers comprising:
a bottom portion having a plurality of side walls and a rear wall extending upwardly therefrom, forming a cavity open on one side,
at least one separating wall within the cavity,
a plurality of compartments within the cavity and separated by said at least one separating wall, and
an integrally molded lid hold down bar comprising a raised rear edge extending upward from the rear wall and at least one protruding tab extending from the rear wall, and wherein there is a clearance gap between said at least one protruding tab and a top of said at least one separating wall.

2. The till tray assembly according to claim 1, wherein said bottom portion has at least one opening aligned with said at least one protruding tab sized and shaped such that a vertical projection of said at least one protruding tab would fit entirely within said opening, allowing the cavity, said at least one separating wall, and said lid hold down bar to be formed as single molded piece.

3. The till tray assembly according to claim 1, further comprising a bill hold down bar formed as a single piece disposed in a parallel relation to the rear wall, and extending between the side walls across a top portion of the cavity.

4. The till tray assembly according to claim 3 wherein said bill hold down bar has at least one seating portion adapted to mate with a cutout at a top portion of said at least one separating wall.

5. The till tray assembly according to claim 4 wherein said at least one seating portion and said cutout are mated and connected to create a fixed interface.

6. The till tray assembly according to claim 5 wherein said at least one seating portion has a V-shaped groove along its edge.

7. The till tray assembly according to claim 6 wherein said cutout has a V-shaped groove to mate with the V-shaped groove of said at least one seating portion.

8. The till tray assembly according to claim 5 wherein said cutout and said at least one seating portion have a trapezoidal profile.

9. The till tray assembly according to claim 5 wherein said fixed interface is created via sonic welding.

10. The till tray assembly according to claim 9, wherein said sonic welding is applied to said at least one seating portion and said cutout resulting in a top of said bill hold down bar aligning flush with a top of said at least one separating wall.

11. The till tray assembly according to claim 1, further comprising a retaining means for retaining objects in said plurality of compartments.

12. The till tray assembly according to claim 11, wherein said retaining means comprises a member extending from said bill hold down bar, said member having at least one end rotatably attached to said bill hold down bar, and a tension element configured to apply a force to said member to bias it toward said bottom portion.

13. The till tray assembly according to claim 12, wherein said tension element extends between said member and the rear wall, and further comprising an attaching means for attaching said tension element to the rear wall.

14. The till tray assembly according to claim 13, wherein said attaching means comprises an aperture in the rear wall, and an aperture reinforcement comprising a thickened portion of the rear wall around said aperture.

15. The till tray assembly according to claim 14, wherein said aperture reinforcement extends downward to said bottom portion.

16. The till tray assembly according to claim 1, further comprising:
at least one separating wall reinforcement being located at an intersection between at least one separating wall and said rear wall, and
said at least one separating wall reinforcement comprising a thickened portion extending along either side of the intersection.

17. The till tray assembly for cash registers comprising:
a bottom portion having a plurality of side walls and a rear wall extending upwardly therefrom, forming a cavity open on one side,
at least one separating wall within the cavity,
a plurality of compartments within the cavity and separated by said at least one separating wall,
a bill hold down bar formed as a single piece disposed in parallel relation to the rear wall and extending between said side walls and across a top portion of the cavity, and
wherein said at least one separating wall comprises a cutout at a top portion of said at least one separating wall adapted to receive a mating portion on a bottom side of said bill hold down bar.

18. The till tray according to claim 17 wherein said side walls comprise a cutout at a top portion of said side walls adapted to receive a mating portion on a bottom side of said bill hold down bar.

19. The till tray according to claim 17, wherein said at least one seating portion and said cutout are mated and connected to create a fixed interface.

20. The till tray assembly according to claim 19, wherein said fixed interface is created via sonic welding.

21. The till tray assembly according to claim 20, wherein sonic welding is applied to said at least one seating portion and said cutout resulting in a top of said bill hold down bar aligning flush with a top of at least one separating wall.

22. The till tray assembly according to claim 17, wherein said cutout has a V-shaped groove adapted to mate with the V-shaped groove of said at least one seating portion.

23. The till tray assembly according to claim 17, wherein said cutout and said at least one seating portion have a trapezoidal profile.

24. The till tray assembly according to claim 17, further comprising a retaining means for retaining objects in said plurality of compartments.

25. The till tray assembly according to claim 24, wherein said retaining means comprises a member extending from said bill hold down bar, said member having at least one end rotatably attached to said bill hold down bar, and a tension element configured to apply a force to said member to bias it toward said bottom portion.

26. The till tray assembly according to claim 25, wherein said tension element extends between said member and the rear wall, and further comprising an attaching means for attaching said tension element to the rear wall.

27. The till tray assembly according to claim 26, wherein said attaching means comprises an aperture in the rear wall, and an aperture reinforcement comprising a thickened portion of the rear wall around said aperture.

28. The till tray assembly according to claim 27, wherein said aperture reinforcement extends downward to said bottom portion.

29. The till tray assembly according to claim 17, further comprising at least one separating wall reinforcement being located at an intersection between at least one separating wall and the rear wall, and said at least one separating wall reinforcement comprising a thickened portion extending along either side of the intersection.

30. The till tray assembly according to claim 17, further comprising an integrally molded lid hold down bar comprising a raised rear edge extending upward from the rear wall and at least one protruding tab extending from the rear wall, and wherein there is a clearance gap between said at least one protruding tab and a top of said at least one separating wall.

31. The till tray assembly according to claim 30, wherein said bottom portion has at least one opening aligned with said at least one protruding tab sized and shaped such that a vertical projection of said at least one protruding tab would fit entirely within said opening, allowing the cavity, said at least one separating wall, and said lid hold down bar to be formed as single molded piece.

32. A till tray assembly for cash registers comprising:
a bottom portion having a plurality of side walls and a rear wall extending upwardly therefrom, forming a cavity open on one side,
at least one separating wall within the cavity,
a plurality of compartments within the cavity and separated by said at least one separating wall,
a bill hold down bar disposed in parallel relation to said rear wall and extending between said side walls and across a top portion of the cavity, and
a retaining means comprising a member extending from the bill hold down bar, said member having at least one end rotatably attached to said bill weight hold down bar, and a tension element configured to apply a force to said member to bias it toward the bottom layer, and
an attaching means for attaching said tension element to the rear wall, and wherein said attaching means comprises an aperture in the rear wall, and an aperture reinforcement comprising a thickened portion of the rear wall around said aperture.

33. A till tray assembly for cash registers comprising
a bottom portion having a plurality of side walls and a rear wall extending upwardly therefrom, forming a cavity open on one side,
at least one separating wall within said cavity,
a plurality of compartments within the cavity and separated by said at least one separating wall, and
at least one separating wall reinforcement in the rear wall.

34. A method of manufacturing a till tray for cash registers comprising:
providing a bottom portion having a plurality of side walls and a rear wall extending upward therefrom, forming a cavity open from a top side,
providing at least one separating wall within the cavity,
providing a reinforcement for said separating wall on the rear wall of the bottom portion,
forming compartments within the cavity by said at least one separating wall,
providing an integrally molded lid hold down bar comprising a raised rear edge extending upward from said rear wall and at least one protruding tab extending from the rear wall, and wherein there is a clearance gap between said at least one protruding tab and a top of said at least one separating wall,
forming a bill hold down bar, disposed in spaced parallel relation to said rear wall and extending between said side walls across a top portion of the cavity,
providing a cutout at a top portion of said at least one separating wall adapted to receive a mating portion of said bill hold down bar,
extending a retaining member from the bill hold down bar, said member having at least one rotatably attached to said bill hold down bar, and providing a tension element configured to apply force to said member to bias it toward the bottom layer, and
attaching said tension element to the rear wall by an attaching means comprising an aperture in the rear wall, and an aperture reinforcement.

35. The method according to claim 34, further comprising applying sonic welding at the point of contact between the top portion of at least one separating wall and the mating portion of said bill hold down bar.
